(19) United States
(12) Patent Application Publication
(10) Pub. No.: US 2006/0180219 A1
(43) Pub. Date: Aug. 17, 2006

(54) Adapter for branching a hose

(76) Inventor: In-Yeol Jeong, Seoul (KR)

Correspondence Address: SUGHRUE MION, PLLC, 2100 PENNSYLVANIA AVENUE, N.W., SUITE 800, WASHINGTON, DC, 20037, US

(21) Appl. No.: 10/562,576

(22) PCT Filed: Dec. 10, 2004
(86) PCT No.: PCT/KR04/03232

§ 371 Date: Dec. 27, 2005

(30) Foreign Application Priority Data
Dec. 10, 2003 (KR) 10-2003-0089561
Jun. 14, 2004 (KR) 10-2004-0043623
Dec. 9, 2004 (KR) 10-20040-0103783

(51) Int. Cl. F16L 37/05

(52) U.S. Cl. 137/798

(57) ABSTRACT

Disclosed is an adapter for branching a hose, in which a plurality of manifolds are connected to a flexible hose to diverge fluid passing though the hose to various direction. The present invention provides adapters of a first aspect related to a head of the adapter for branching a hose and its modifications, in which the head is inserted into one of holes formed at the hose, and a second aspect related to an inserting unit of the head of the adapter for branching a hose and its modifications such that the head can be easily inserted to one of the holes of the hose. The adapter includes a body shaped as a pipe, a head and a coupling unit. The body includes a passage therein, an inlet inserted into the hose, and an outlet connected to the manifold, which is pro-truded from the hose when the adapter is installed to the hose. The head formed at the inlet side of the body is insertedly connected to the hole of the hose. The coupling unit is formed at the outer surface of the body. The adapter can be easily connected to even a flat folded hose and can prevent fluid from leaking based on tight sealing.

### TECHNICAL FIELD

The present invention relates to an adapter for branching a hose, and more particularly to an adapter for branching a hose capable of connecting a plurality of manifolds to one side of the hose such that flow paths of a fluid can be distributed in a plurality of directions.

### BACKGROUND ART

In general, a hose is a kind of pipe, made of flexible materials such as rubber, resin, cloth, etc., utilized in applications where transferability and mobility are required, due to its bendable nature.

Hoses may be classified into rubber hoses, plastic hoses, and metal hoses based on the material from which they are made. Rubber hoses are made of natural rubber, synthetic rubber, reclaimed rubber, etc., and are divided into braid hose and general purpose, in which the braid hose has characteristics such as relatively high flexibility and resistance to pressure.

Plastic hoses are flexible pipes made of polyvinylchloride and ployethylene, and used for household applications as well as in agriculture and irrigation. Metal hoses are made by spirally weaving thin strips of steel, copper, copper alloy, aluminum, etc., and then packing the strips with rubber or asbestos to impart them with characteristics such as sealing and flexibility. The metal hose is used for conveying hot fluid, gas, vapor, water, oil, etc., or is utilized as a protective pipe or an elastic pipe in which electric wires are included, etc.

According to their applications, hoses may be classified into transportation hose, oil hose, high or low pressure hose, adsorption hose, air hose, oxygen hose, acetylene hose, vapor hose, agricultural hose, irrigation hose, gardening hose, etc. Also, the hose further includes heat resistant and oil hose, solution hose, etc., which are formed by a tube made of nylon or Teflon® as opposed to a rubber tube.

On the other hand, such a hose often requires a plurality of manifolds which are connected to the hose for distributing 90° or any other angles, such that the hose conveys fluids such as water from a source, gas, etc. to corresponding destinations. Also, the agricultural hose may need a connection in which one end or both ends of the hose are connected to the manifolds to periodically or continuously sprinkle water to farm products in a farm or a garden. For these purposes, various adapters are developed and disclosed.

FIGS. 1 and 2 are perspective views illustrating a prior art adapter for branching a hose.

As shown in FIG. 1, the prior art adapter of a hose 100 includes a body 110, a head 120, and a coupling member 130. The body 110 has an inlet 111 at one end, in which the inlet 111 is connected insertedly into a hose and receives a fluid from the outside via the hose, and an outlet 112 conveying the fluid flowing in via the inlet 111 to another hose. The head 120 is formed at the inlet 111 of the body 110 and has an inserting groove 121 at one end, which is formed in a cutting manner. The coupling member 130 is located at a predetermined position of the body 110.

The adapter of a hose 100 is installed to a hose such that, after a hole of a predetermined diameter is formed at a predetermined position, the inserting groove 121 of the head 120 is inwardly located at the edge of the hole and then the head 120 is rotated to forcibly insert the head 120 into the hose.

However, since the prior art adapter of a hose 100 is installed to a hose such that the inserting groove 121 of the head 120 is inwardly located at the edge of a hole of the hose with a predetermined depth and then the head 120 is forcibly inserted into the hose by applying an external force thereto, it has a disadvantage in that the head 120 cannot be easily inserted into the inside of the hose. Also, the prior art adapter of a hose 100 has drawbacks in that the installing operation causes damage to the hole formed at the hose or enlarges the diameter of the hose such that fluid can be leaked through a contact portion between the adapter 100 and the hose.

In order to resolve such problems, as shown in FIG. 2, an adapter for branching a hose 100 has been proposed. The manifold connection was modified from the adapter for branching a hose 100 of FIG. 1 to have an inserting plate 123 extensibly formed at one side of the head 120 thereof.

Such a adapter for branching a hose 100 with an inserting plate 123 is installed into a hole formed at a hose such that the inserting plate 123 of the head 120 is inwardly located to the hole as long as its length can be inserted thereto without applying force thereto and then the head 120 is forcibly inserted into the hose by applying an external force thereto. However, since the adapter for branching a hose 100 with an inserting plate 123 is insertedly installed into the hose by applying an external force to the inserting plate 123 of the head 120, it has disadvantages in that the diameter of the hole formed at the hose is enlarged or the hole is damaged such that that fluid can be leaked through a contact portion between the adapter 100 and the hose, thereby damaging the hose.

Meanwhile, since flexible hoses made of flexible material, such as rubber or synthetic resin, etc., are highly flexible and bendable, they can generally be wound into a roll with flat folding and then stored.

Therefore, when adapters for branching a hose are installed into the holes formed at one of such flexible hoses and, worse, if a hose is relatively long and wide, the hose requires tedious manual work due to the weight of the hose.

Namely, a worker must individually extend the holes in a flat folded hose, which is relatively long, and then insert the adapters for branding a hose thereinto. Also, since the relatively long hose is kept in flat folded state by the weight of the hose, it has disadvantages in that operations for installing the adapters to the holes of the hose cause worker difficulty such that the worker must individually extend the holes in a flat folded hose and then insert them into the extended holes, respectively.

### DISCLOSURE OF INVENTION

[Technical Problem]

Therefore, the present invention has been made in view of the above problems, and it is an object of the present invention to provide a adapter for branching a hose capable of insertedly installing to a hose to easily separate fluid passing though the hose to predetermined places, of providing a facility for use such that it can be easily installed to a predetermined position of the hose and the hose can be easily separated thereby, of providing a facility such that it can be easily installed to an unroll hose which is not evenly spread, of providing a facility such that it can be easily installed to a hose in a state wherein it is folded, of relatively securely connecting to the hose such that it cannot be easily separated from the hose, and of providing a relatively tight seal such that fluid cannot leak from connection parts between the adapter and the hose.

[Technical Solution]

The present invention provides first and second aspects, in which the first aspect is related to a head of the adapter for branching a hose and its modifications, in which the head is inserted to one of holes formed in the hose, and the second aspect is related to an inserting unit of the head of the adapter for branching a hose and its modifications such that the head can be easily inserted into one of the holes of the hose.

Sequentially, the first and second aspects are described below.

In accordance with an aspect of the present invention, the above and other objects can be accomplished by the provision of a adapter for branching a hose, insertedly connected to an edge of the hose, to distribute fluid flowing through the hose, comprising: a body for conveying the fluid, the body including an inlet and outlet at its one end and other, respectively; a head formed at a predetermined position of the inlet side of the body, the head being formed as a downwardly tapered cone; and coupling units at the inlet and outlet sides of the body.

Preferably, the head is configured to be connected by insertion into the body or is configured to be screwed to the body. The head may include screw threads outwardly protruded from its outer surface, sloping at a predetermined angle.

Preferably, the head includes one or more extension plates inwardly protrudently at its inner surface, in which the extension plate may be gradually decreased in size from one end to the other.

Also, the head may include a screw groove having a predetermined size at the outer surface thereof, in which the screw groove is sloped at a predetermined angle.

Alternatively, the head may include one or more extension plates inwardly protrudently at its inner surface, in which the extension plate may be gradually decreased in size from one end to the other.

Preferably, a locking step unit protrudes from an outer edge at the end of the inlet side of the body. An extension groove may be formed at a predetermined position by cutting in the length direction, and extensible, in which plural extension grooves are formed by cutting along the periphery. The extension plate may be formed to be insertedly connected to the extension groove.

Preferably, a head cap is connected by insertion into the end of the inlet of the body. The head cap may be shaped as a cylinder, in which the diameter of the head cap gradually decreases from one end to the other. A fixing step is outwardly protrudently formed at one end of the outer surface of the head cap.

Also, a coupling unit may be coupled thereto in a screw connection manner, etc., and may include a first coupling member at a predetermined position in an end of an inlet side of the body and a second coupling member at a predetermined position in an end of an outlet side of the body. The body may include a plurality of stoppers at predetermined positions of the outer surface thereof, in which the stoppers are outwardly protrudently formed. Here, the outlet side may be modified to various coupling means depending on the adapters to be connected thereto.

Alternatively, a plate shaped packing may be prepared at one side of the head, in which the packing is made of synthetic resin or synthetic rubber. Also, the end of the head may be shaped as a wedge sloping with a predetermined angle.

Preferably, a locking step unit is outwardly protrudently formed at an outer edge at end of the inlet side of the body. An extension groove may be formed at a predetermined position by cutting lengthwise, and extensible, in which plural extension grooves are formed by cutting along the periphery. The extension plate may be formed to be insertedly connected to the extension groove.

Also, a coupling unit may be coupled thereto in an inserting connection manner or a screw connection manner, etc., and include a first coupling member at a predetermined position in an end of an inlet side of the body and a second coupling member at a predetermined position in an end of an outlet side of the body. The body may include a plurality of stoppers at predetermined positions of the outer surface thereof, in which the stoppers are outwardly protrudently formed. Here, the outlet side may be modified to various coupling means depending on the adapters to be connected thereto.

In addition, a plate shaped packing may be prepared at one side of the head, in which the packing is made of synthetic resin or synthetic rubber. Also, the one end of the head may be shaped as a wedge sloping at a predetermined angle.

Further, the body may include a plurality of stoppers at predetermined positions of the outer surface thereof, in which the stoppers are outwardly protrudently formed.

In accordance with another aspect of the present invention, there is provided a adapter for branching a hose, comprising: a body including a passage through which fluid passes in the inside thereof, an inlet formed at one end thereof to be inserted into a hose, and an outlet formed at the other end thereof to be connected to the adapter, the outlet being protrudently installed to the hose; a head formed at the inlet side of the body, the head being insertedly connected to a hole of the hose; and a coupling unit including a coupling member, in which the coupling member is arranged adjacent to the inlet and coupled to a coupled member such as an inserting groove or screwing unit formed at an outer surface of the body. Here, the head includes an inserting unit irregularly formed on an upper surface thereof and a pressing unit formed on a lower surface thereof, in which the inserting unit has a width smaller than that of the pressing unit and the pressing unit has a diameter greater than that of the hole of the hose.

The pressing unit further includes a packing member at the lower side thereof, which is made of rubber, etc. to enhance sealing. A locking step may be further added thereto to fix the packing member thereto, in which the locking step is protruded from the lower position of the head of the body to the radial direction.

In the second aspect, the head may be assembled to the inlet side of the body in a screw connection manner, etc., or formed to be integrated with the inlet of the body.

The inserting unit may be shaped as a part of hemisphere, in which the inserting unit is formed such that three quarters with respect to the vertex of the hemisphere are cut off leaving a quarter of the hemisphere and the inlet close to the vertex, with respect to a top view, and cut of at the inlet, with respect to a cross-sectional view of the inserting unit. The coupling unit may include a coupling member shaped as a pipe and a coupled member formed at the outer surface of the body. The coupling unit is a sealing means to closely press a lower surface of the pressing unit or a packing member, which is inserted to a hole of a hose, and the hose, such that leakage cannot occur at the hole. The coupled member indicates an inserting groove or a screw thread formed on the outer surface of the body. The coupling member forms a pipe in its inner side and protrusions, etc., on the outer surface to be easily rotated or gripped by a user. Since the inner surface of the coupling member forms a protrusions or a screw groove, etc., when the coupling member is pressed and inserted to the inserting groove, it can press the hose or couple to the screw thread such that the hose can be pressed from the upper side. Such coupling means is merely an example and instead can be modified without departing from the sprit of the present invention.

The coupling member may form a slope surface at an inner circular surface of the upper side thereof, in which the slope surface increases in diameter from the center outward, such that the slope surface can apply a pressure to an outer surface of the hose in the sloped direction. The coupling unit may form a flat surface applying a pressure to the pressing unit, at an inner circular surface of the upper side thereof, and a taper unit from an outer part of the flat surface from the end of the inner circular surface of the upper side thereof. Therefore, the coupling member can enhance the coupling force of the adapter for branching a hose according to the present invention.

A shortest distance between the cut part and an edge part of the pressing unit of the head may be smaller than a diameter of the hole of the hose.

The pressing unit may include a guide groove at left, right or both sides thereof such that the pressing unit is smoothly inserted thereinto when the adapter is rotated to be installed to the hose.

The coupling member may include a stopper at the lower side thereof such that it cannot be move down and escape therefrom. Connection between the lower part of the inlet and an additional adapter is implemented with various connection manners such as screw connection or forcible insertion, etc.

[Advantageous Effects]

The adapter for branching a hose according to the present invention can be easily inserted to mount to the hose such that high pressure fluid passing though the hose can be guided to predetermined places. It can provide a facility for use such that it can be easily installed and separated from a predetermined position of the hose. It cannot be easily separated from the hose once connected thereto. Even if the hose is flat due to decrease of the inserting unit of the hose, cutting part, and hose weight, it can easily be inserted into the hole as it is placed on an edge of the hole without widening the flat hose. It can be easily guided to the hole by guiding grooves formed at both sides of the inserting unit when it is rotated and pressed to be inserted into the hole. A protruding unit additionally formed at the end of the inserting unit enables the adapter for branching a hose to be more smoothly inserted into the hose. When the coupling member is tighten by the slope surface formed at the inner surface at the upper side thereof, the hose, the packing member, and the pressing unit are closely connected to secure its high sealing. The hose and the packing member are further sealed by a circular sealing protruding unit formed at the flat surface in the coupling member and a circular sealing groove formed at the lower surface of the pressing unit such that its sealing is more enhanced. The adapter can be easily inserted and connected to a hole of a flexible hose. Therefore, based on the connections mentioned above, the adapter for branching a hose according to the present invention can secure a high sealing such that leakage does not occur.

### DESCRIPTION OF DRAWINGS

The above and other objects, features and other advantages of the present invention will be more clearly understood from the following detailed description taken in conjunction with the accompanying drawings, in which:

FIGS. 1 and 2 are perspective views illustrating a prior art adapter for branching a hose;

FIG. 3 is a perspective view illustrating an adapter for branching a hose according to the present invention;

FIG. 4 is a perspective view illustrating an adapter for branching a hose according to a first embodiment of the present invention;

FIG. 5 is an exploded perspective view illustrating an adapter for branching a hose according to a first embodiment of the present invention;

FIG. 6 is a view illustrating an adapter for branching a hose according to a first embodiment of the present invention in use;

FIG. 7 is a schematic cross-sectional view illustrating a head of the adapter for branching a hose according to a second embodiment of the present invention;

FIG. 8 is a schematic cross-sectional view illustrating a head of the adapter for branching a hose according to a third embodiment of the present invention;

FIG. 9 is a view illustrating a general flexible hose and holes formed on the flexible hose;

FIG. 10 is a partially cross-sectional view illustrating an adapter for branching a hose according to a fourth embodiment of the present invention;

FIG. 10a is a partially cross-sectional view illustrating an alternative example of an adapter for branching a hose according to a fourth embodiment of the present invention;

FIG. 11 is a partial cross-sectional view illustrating an adapter for branching a hose according to a fifth embodiment of the present invention;

FIG. 11a is a partial cross-sectional view illustrating an alternative example of an adapter for branching a hose according to a fifth embodiment of the present invention;

FIG. 12 is a partial cross-sectional view illustrating an adapter for branching a hose according to a sixth embodiment of the present invention;

FIG. 12a is a partial cross-sectional view illustrating an alternative example of an adapter for branching a hose according to a sixth embodiment of the present invention;

FIG. 13 is a partial cross-sectional view illustrating an adapter for branching a hose according to a seventh embodiment of the present invention;

FIG. 13a is a partial cross-sectional view illustrating an alternative example of an adapter for branching a hose according to a seventh embodiment of the present invention;

FIG. 14a is a partial cross-sectional view illustrating an adapter for branching a hose according to an eighth embodiment of the present invention;

FIG. 14b is a top view of FIG. 14a taken along the direction of arrow B;

FIG. 15 is a view illustrating a state wherein the adapter for branching a hose according to the fourth embodiment of the present invention is installed on a hole of a hose;

FIGS. 16a and 16b are enlarged views of portion A of FIG. 15;

FIG. 17a is a partially cross-sectional view illustrating an adapter for branching a hose according to a ninth embodiment of the present invention;

FIG. 17b is a partially cross-sectional view illustrating an adapter for branching a hose, in which an inserting unit is modified from the ninth embodiment of the present invention;

FIG. 18a is a perspective view illustrating an adapter for branching a hose according to a ninth embodiment of the present invention;

FIG. 18b is a top view of FIG. 18a taken along the direction of arrow B;

FIG. 19a is a perspective view illustrating a state before a adapter for branching a hose according to a ninth embodiment of the present invention is inserted into a hole of a flexible hose;

FIG. 19b is a cross-sectional view of FIG. 19a taken along line B-B′;

FIG. 19c is a cross-sectional view of FIG. 19b, rotated 90° clockwise;

FIG. 19d is a cross-sectional view of FIG. 19c illustrating a state after the manifold member for a hose is fitted in the hole of the flexible hose as it is rotated and pressed;

FIG. 20a is a cross-sectional view illustrating a state wherein the manifold member for a hose according to the ninth embodiment of the present invention is completely coupled to the hole;

FIG. 20b is a partially enlarged view of portion C of FIG. 20a, illustrating a state wherein a sealing protrusion unit is added to the manifold member for a hose; and

FIG. 20c is a partially enlarged view of FIG. 20b, illustrating a state wherein sealing grooves are added to the manifold member for a hose.

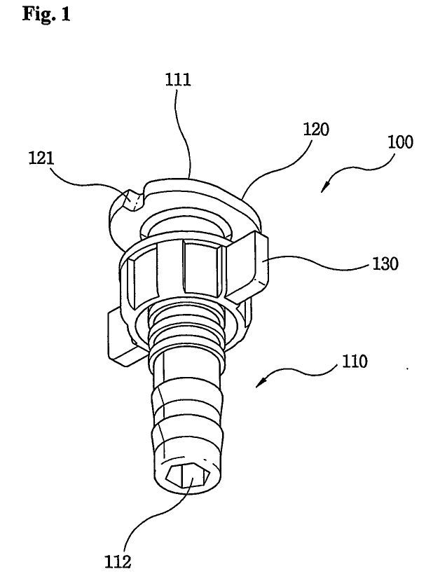

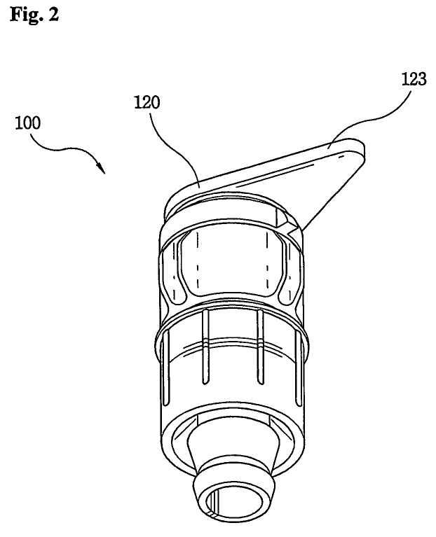

### BEST MODE FOR CARRYING OUT THE INVENTION

The embodiments of the present invention are described in detail below with reference to the drawings.

Sequentially, the first and second aspects are described below.

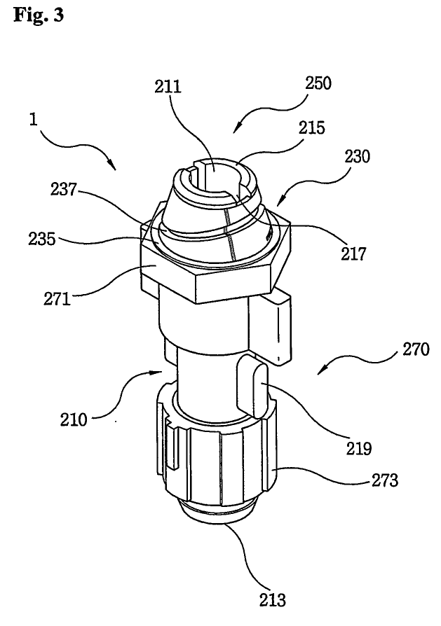

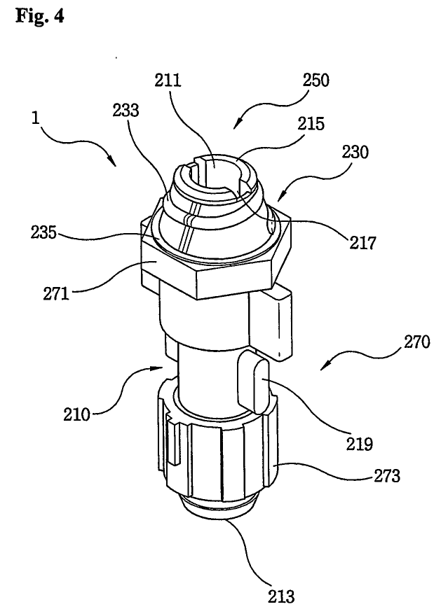

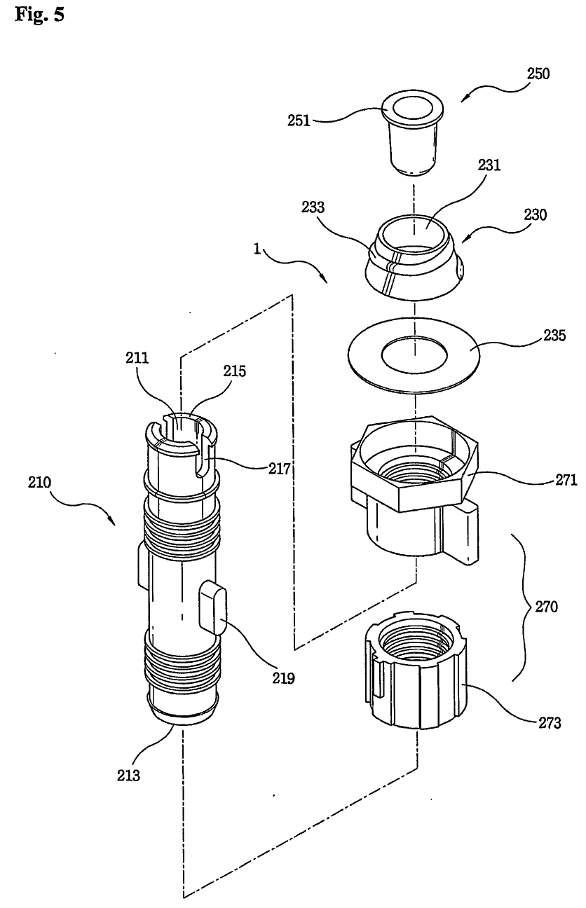

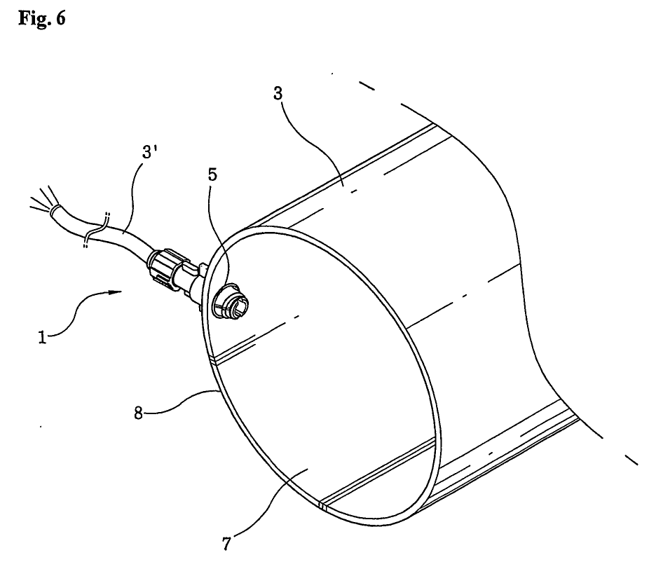

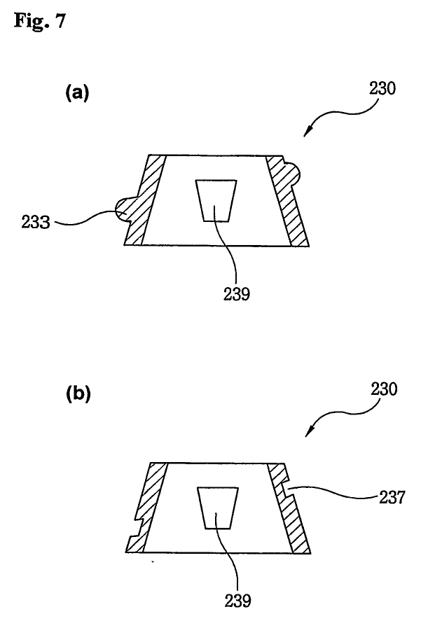

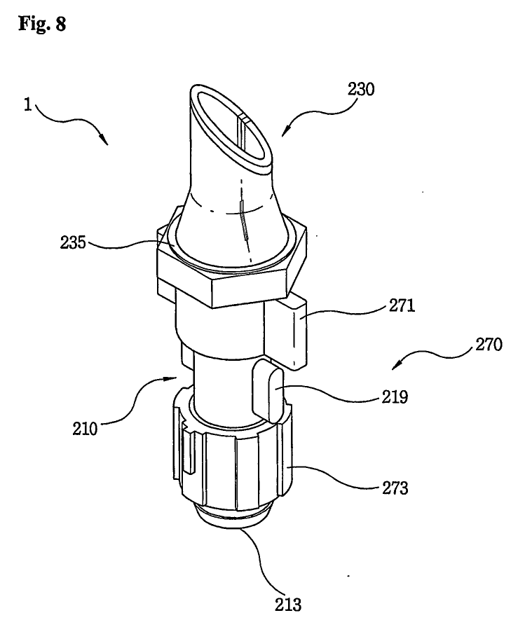

The embodiments for the first aspect of the present invention are illustrated through FIGS. 3 to 8. FIG. 3 is a perspective view illustrating a adapter for branching a hose according to the present invention. FIG. 4 is a perspective view illustrating an adapter for branching a hose according to a first embodiment of the present invention. FIG. 5 is an exploded perspective view illustrating an adapter for branching a hose according to a first embodiment of the present invention. FIG. 6 is a view illustrating an adapter for branching a hose according to a first embodiment of the present invention in use. FIG. 7 is a schematic cross-sectional view illustrating a head of the adapter for branching a hose according to a second embodiment of the present invention. FIG. 8 is a schematic cross-sectional view illustrating a head of the adapter for branching a hose according to a third embodiment of the present invention.

As shown in the drawings, the adapter 1 for a hose according to the present invention includes a body 210, a head 230, a head cap 250 and a coupling unit 270.

The body 210 and the head 230 are connected in a screw connection manner (not shown). Namely, the screw connection is performed such that the head 230 forms a female screw on its inner circular surface and the body 210 forms a male screw on an inlet 211 thereof, or such that the head 230 forms a male screw on one side of the outer surface thereof and the body 210 forms a female screw on the inner circular surface of the inlet 211 thereof.

As shown in the drawings, the head 230 forms a screw groove 237 having a predetermined size and depth on the outer surface thereof, in which the screw groove 237 is formed on the outer surface of the head 230 sloping with a predetermined angle. The head 230 is insertedly connected to the inlet 211 of the body 210 of the adapter 1.

Such a structure of the adapter 1 for a hose provides a facility that, when the adapter 1 for a hose is insetetdly installed to a predetermined position of the hose 3, the head 230 of the body 210 can be easily installed to the hose 3. Namely, after a hole 5 whose diameter is smaller than that of the head 230 is formed at the hose 3, the head 230 is inserted into the hole 5.

When a user rotates the adapter 1 for a hose applying a force thereto, the screw groove 237 is also rotated to the edge of the hole 5 such that the head 3 is inserted into the hose 3.

Therefore, based on the structure of the adapter 1 for a hose, the head 230 can be easily inserted and installed to the predetermined position of the hose 3.

More specifically, the present invention is described in detail based on a first embodiment thereof below.

The body 210 includes an inlet 211 at one end thereof and an outlet 213 at the other end thereof and is formed to pass fluid through the inside thereof. The inlet 211 forms outwardly protrudently a locking step 215 at the end thereof. Also, the inlet 211 having the locking step 215 forms extensible grooves 217 at the end thereof, in which the extensible grooves 217 are cleaved with a predetermined length in the length direction of the body 210 and formed along the periphery of the inlet 211. The extensible grooves 217 are formed more than one.

Although the extensible grooves 217 according to the first embodiment of the present invention are implemented to be formed by two at predetermined positions along the periphery of the end of the inlet 211, more than two of the extensible grooves 217 can be included therein if extension of the inlet 211 may be required.

The head 210 includes a plurality of stoppers 219 which are outwardly protrudently formed at predetermined positions of the outer surface thereof. Each stopper 219 is shaped as a hexahedron. Although the stoppers according to the embodiment of the present invention are implemented to be formed by two, more than two of the stoppers may be implemented. Also, even though the shape of the stopper according to the embodiment of the present invention is implemented to be hexahedral, various shapes may be formed.

On the other hand, the body forms a male screw at a predetermined position of the inlet side such that it can connect to a first coupling member 271 of the coupling unit 270 and a male screw at a predetermined position at the end of the outlet side such that it can connect to a second coupling member 273 of the coupling unit 270.

The head 230 forms a though hole 231 in its inside to insertedly connect and couple to the outer surface of the inlet 211 of the body 211. The head 230 gradually increases in diameter from one end to the other. Namely, the head 230 is shaped as a cone, or tapered.

On the other hand, the diameter of the through hole 231 formed within the head 230 is greater than that of the body 210 such that it can be insertedly coupled to the outer surface of the inlet 211.

The head 230 forms a screw thread 233 sloping with a predetermined angle on the outer surface thereof. The screw thread 233 is outwardly protrudently formed along the periphery direction of the head 230. Such a screw thread 233 formed on the outer surface of the head 230 provides a facility that, when the adapter 1 for a hose is insertedly installed to a predetermined position of the hose 3, the head 230 of the body 210 can be easily installed to the hose 3.

Namely, when the head 230 is located to a hole 5 of the hose 3 and the adapter 1 for a hose is rotated, the screw thread 233 enables the head 230 to be easily inserted into the hole 5 such that the screw thread 233 of the head 230 is rotated along the edge of the hole 5 of the hose 3. Here, even if the size of the hole 5 is formed smaller than the maximum diameter of the head 230, the head 230 having such a screw thread 233 can be easily inserted into the hole 5.

On the other hand, the head 230 includes a disc shaped packing at one end thereof, in which the packing is made of synthetic resin or a synthetic rubber. The packing 235 prevents fluid flowing in a hose 3 from leaking at a portion between the hose 3 and the head 230 insertedly installed to the hose 3.

Namely, when the head 230 is insertedly installed into the hose 3, the packing 235 is closely coupled to the inner wall 7 of the hose 3 to cover and seal a gap between the hose 3 and the adapter 1, thereby preventing fluid passing through the hose 3 from leaking.

Even though the packing 235 according to the first embodiment of the present invention is implemented with a circular disc form, various shapes such as a rectangle, etc., may be possible assuming that covering and sealing effects are secured.

The head cap 250 is formed as a cylinder whose diameter is gradually decreased from one end to the other. The head cap 250 includes a fixing step 251 outwardly protrudently formed on the outer periphery at one end thereof.

The coupling 270 according to the present invention includes a first coupling member 271 and a second coupling member 273, in which the first coupling member 271 is included at a predetermined position of the inlet side of the body 210 and the second coupling member 273 is included at a predetermined position of the end of the outlet side of the body 210.

When the adapter 1 is insertedly installed into the hose 3, the first coupling member 271 closely tightens the head 230 located within the inside of the hose 3 and the inner wall 7 of the hose 3 to tightly keep a connection portion between the adapter 1 and the hose 3.

The second coupling member 273 tightens another hose 3′ or a pipe which is insertedly connected to the outlet 213 of the body 210.

Here, the hose 3′ is connected to the outlet 213 of the body 210 to separate fluid flowing though the hose 3 to a predetermined place.

To achieve the above functions, the first and second coupling members 271 and 273 form female screws on the inner circular surfaces, and the body 210 forms male screws on the outer surfaces corresponding respectively to the female screws of the first and second coupling members 271 and 273 at predetermined positions thereof. Therefore, the coupling is performed by the body 210 and the first and second coupling members 271 and 273.

On the other hand, the first and second coupling members 271 and 273 are located at opposite sides with respect to the stopper 219 formed at a predetermined position of the outer surface of the body 210. The stopper 219 prevents the first and second coupling members 271 and 273 from mutually interfering. Also, the stopper 219 prevents the first and second coupling members 271 and 273 from completely escaping from the respective male screws formed at the body 210 when the first and second coupling members 271 and 273 are performed the release operations.

Namely, when the female screws of the first and second coupling members 271 and 273 are released from the female screws of the body 210, even if the first and second coupling members 271 and 273 are released at predetermined turns, the stopper 219 located between the first and second coupling members 271 and 273 prevents them from completely escaping from the male screws, respectively.

As such, due to the stopper 219, in the tightening and releasing operations between the female screws of the first and second coupling members 271 and 273 and corresponding screws of the body 210, the first and the second coupling members 271 and 273 are not completely escaped from the body 210 and also not interfered to one another.

The first and second coupling members 271 and 273 form a plurality of protrusions on the outer surfaces thereof to provide a facility for tightening and releasing operations to a user. Even though the first and second coupling members 271 and 273 according to the embodiment of the present invention have protrusions as shown in the drawings, various types of protrusions may be modified therefrom and adopted thereto.

Now, a procedure for assembling the adapter 1 for a hose as configured above is described in detail below.

Firstly, the first coupling member 271 is passed through the inlet 211 of the body 210 after insertedly connecting to the inlet 211, and then is coupled to the male screw formed at the outer surface of the body 210. The first coupling member 271 is located at a predetermined position of the body 210 by the stopper 219 protrudently formed at the body 210.

The head 230 is insertedly connected to the body 210 as force is applied to the locking step 215 outwardly protrudently formed at the end of the inlet side of the body 210. Namely, as a force is applied to the inlet side of the body 210, which is extensible by extensible grooves 217 are formed at the inlet side, the inlet is deformed such that the diameter and external appearance of inlet are reduced smaller than the through-hole 231 of the head 230 and thusly the head 230 is insertedly connected to the inlet side of the body 210.

After the head is insertedly connected to the inlet side of the body 210, the inlet 211 restores its original diameter and external appearance as the force applied to the inlet side is removed. Here, a packing 235 made of synthetic resin or synthetic rubber is installed to one end of the head 230 such that it is integratedly insertedly coupled to the body 210.

As such, the head 230 is securely coupled to the body 210 by the locking step 215 outwardly protrudently formed at the end of the inlet 211.

After that, the head cap 250 is insertedly connected to the inside of the inlet 211. Since the head cap 250 is formed to gradually decrease in diameter from one end to the other end, the inlet 211 is extended in the radial direction with respect to its centerline.

Namely, when the head cap 250 is insertedly connected to the inlet 2110, one end of the head cap whose diameter is relatively smaller than that of the other end is located at a farther position from the inlet entrance and the other end of the head cap 250 is located at the inlet entrance. Here, the relatively large diameter end of the head cap 250 extends the inlet entrance, because the inlet includes the extensible grooves.

Preferably, the size of the inlet is formed to be smaller than the diameter of the relatively large diameter end of the head cap 250 such that the head cap is insertedly connected to the inlet in an extensible connection manner.

Therefore, since the inlet 211 is extensibly connected to the head cap 250 as the head cap 250 is inserted into the inlet 211, the connection therebetween is relatively tight and does not allow movement of the head cap with respect to the inlet.

On the other hand, a fixing step 251 formed at one end of the head cap 250 enables the head cap 250 to be inserted into the inlet 211 until the fixing step 251 reaches the end of the inlet 211, which means a state wherein the coupling is complete therebetween.

The second coupling member 273 passes through the outlet 213 of the body 210 after being insertedly connected to the outlet 213, and then coupled to the male screw formed at the outer surface of the body 210. The second coupling member 273 is located at a predetermined position of the body 210 by the stopper 219 protrudently formed at the body 210. Therefore, the procedure for assembling the adapter 1 for a hose is completed.

A procedure of installing the adapter 1 according to the present invention into a hose 3 is described in detail below. The adapter 1 is installed to the hose 3 through which high pressure fluid passes.

Namely, a hole 5 is formed at a predetermined position of the outer surface of the hose 3 to separate fluid passing through the hose 3 to a desired direction. The head 230 of the adapter 1 is inserted into the hole 5.

The hole 5 is preferably formed smaller than the diameter of the head 230 such that, when the head 230 is rotated and terminated to be insertedly installed to the hose 3, the hole 5 tightly tightens the head 5.

Since the head 230 includes screw threads 233 outwardly protruded from the outer surface thereof, the head 230 is easily inserted and installed to the hose by the screw thread 233. Namely, when the adapter 1 is rotated to the hole 5 of the hose 3, the screw threads 233 of the head 230 are also rotated along the edge of the hole 5. Therefore, the head 230 can be easily inserted and installed into the hole 5.

On the other hand, the hose 3 is formed to preferably have a diameter or a size to install a plurality of adapters thereto.

After the head 230 is rotated and installed into the hole 5 of the hose 3, the first coupling member 271 located at one end of the head 230 is rotated to tighten the head 230 and the hose 3.

Namely, after the head 230 is inserted and installed to the hole 5 of the hose 3 such that the wall surfaces 7 and 8 are located between the head 230 and the first coupling member 271, the first coupling member 271 is rotated to tighten between the inner wall surface 7 of the hose 3 and the head 230 and between the external wall surface 8 and the first coupling member 271 together. Here, the hose is located between the head 230 and the first coupling member 271. Therefore, such connection can prevent fluid passing thorough the hose 3 from leaking through the connection portion between the adapter 1 and the hose 3.

Fluid passing though the hose is prevented from leaking not only by the head 230 and the first coupling member 271 tightly coupled to the inner and external wall surfaces 7 and 8, but also by the packing 235 included at one end of the head 230.

Namely, when the head 230 is inserted and installed into the hose 3, the packing 235 is closely installed to the inner wall surface 7 of the hose 3. The packing 235 is closely coupled to the inner wall surface 7 as the first coupling member 271 is tightened such that it can cover and seal the hole 5 of the hose 3. Therefore, fluid passing thorough the hose 3 is prevented from leaking at the connection portion between the adapter 1 and the hose 3.

After the adapter 1 is inserted and installed to the hole 5 of the hose through the head 230 formed at the inlet side thereof, the outlet 213 of the adapter 1 is connected to another hose 3′ to convey fluid passing though the hose 3 to a predetermined place via the hose 3′.

Here, the hose 3′ preferably has a size corresponding to that of the outlet 213.

The hose 3′ is insertedly connected to the outlet 213 by the second coupling member 273.

Namely, the hose 3′ insertedly connected to the outer surface of the outlet side is located between the outlet 213 and the second coupling member 273 and closely tightened between the outer surface of the outlet side and the inner surface of the second coupling member 273 as the second coupling member 273 is rotated to be tightened.

Such connection enables the hose 3 to be tightly connected and fixed to the adapter 1 and prevents fluid from leaking through the connection portion between the outlet 213 of the adapter 1 and the hose 3′.

Therefore, installation procedure for the adapter 1 according to the present invention is terminated as its inlet 211 and outlet 213 are connected to the hose 3 and another hose 3′, respectively. Here, the hose 3′ can be further connected to an additional manifold hose (not shown) or a sprinkler (not shown) to convey fluid from the hose 3 to a predetermined place.

FIG. 7 is a schematic cross-sectional view illustrating a head of the adapter for branching a hose according to a second embodiment of the present invention. Namely, the inner configuration of the head of the adapter for branching a hose is modified. As shown in the drawing, the head 230 includes plural extension plates 239 inwardly protrudently at predetermined positions of the inner surface thereof. The extension plate 239 is shaped as a bar type (not shown) or shaped such that its size is gradually decreased from one end to the other. The extension plate 239 is insertedly connected to an extension groove 217 of the body 210.

A procedure for coupling the head 230 and the body 210 is described in detail below. Firstly, force is applied to a locking step 215 formed at the outer surface of the end of the inlet 211 such that the head 230 is insertedly connected to the body 210.

Here, after the respective extension plates 239 formed at the inner surface of the head 230 are correspondingly located at the extension grooves 217 formed at the end of the inlet 211, the head 230 is connected to the body 210.

Namely, after force is applied to the locking step 215 to reduce the diameter of the inlet 211, the respective extension plates 239 are positioned in corresponding extension grooves 217 formed at the inlet 211. Therefore, as the head 230 is insertedly connected to the body 210, the extension plates 239 are insertedly connected to the extension grooves 217, respectively.

Here, when the extension plates 239 are gradually connected to the extension grooves 217 as the head 230 is pressed at a predetermined pressure, the extension plates 239 are connected to the extension grooves 217 while the extension plates 239 are sliding and widening the extension grooves 217 because its size is gradually decrease from one end to the other end.

Namely, when the extension plates 239 are inserted and connected to the extension grooves 217, as the relatively smaller part of the extension plate 239 is firstly slidably connected to the extension groove 217 and then the relatively larger part of the extension plate 239 is connected thereto, the inlet 211 of the body 210 is maximally extended. Therefore, the head 230 and the body 210 are positioned nearby one another by extension of the extension groove 217 such that the connection and fixing can be enhanced therebetween.

Since the extension plates 239 formed in the inner surface of the head 230 are insertedly connected to the extension grooves 217 formed at the inlet 211 of the body such that the inlet 211 can be extended, such connection does not require a head cap 250, and instead tightly connects and fixes the head 230 to the body 210.

FIG. 8 is a schematic cross-sectional view illustrating a head of the adapter for branching a hose according to a third embodiment of the present invention, in which a head of the adapter is partially modified. As shown in the drawing, the adapter 1 is shaped as a wedge in the end of the inlet 211 of the head 230 thereof, sloping at a predetermined angle.

As the end of the inlet 211 of the head 230 is formed to be a wedge, the head 230 of the adapter 230 can be easily inserted and installed to a hose 3 through a hole 5 of the hose. Especially, although the hose 3 does not have the hole 5 previously formed at a predetermined position thereof, the adapter 1 having a wedged inlet can be insertedly installed to the hose such that, as the head 230 with the wedge shaped inlet is rotated with respect to a predetermined position of the outer surface of the hose 3 at a predetermined pressure and thusly, the head can be inserted into the hose 3 by the inlet.

On the other hand, in the first embodiment of the present invention, although the head 230 of the adapter 1 is implemented with a wedge shape, assuming that the head 230 is easily inserted and installed into the predetermined position of the hose 3, the screw thread 233 outwardly protrudently from the outer surface of the head may be implemented to be sloped at a predetermined angle and the screw groove 237 having a predetermined size and depth at the outer surface of the head may be implemented to be sloped at a predetermined angle.

Also, the head 230 of the adapter 1 may include more than one of the extension plates 239 at predetermined positions of the inner surface thereof such that the extension plates 239 can be insertedly connected to the extension grooves 217 of the body 210. Here, the extension plate 239 is formed to gradually decrease in size from one end to the other end.

On the other hand, the head shaped as a wedge may further include a packing 235 made of synthetic resin or synthetic rubber at one end thereof such that covering and sealing effects can be more enhanced between the head and the inner wall surface of the hose 3 when it is inserted and installed into the hose 3.

Embodiments for the second aspect of the present invention are described in detail with reference to the drawings of FIGS. 6 to 20.

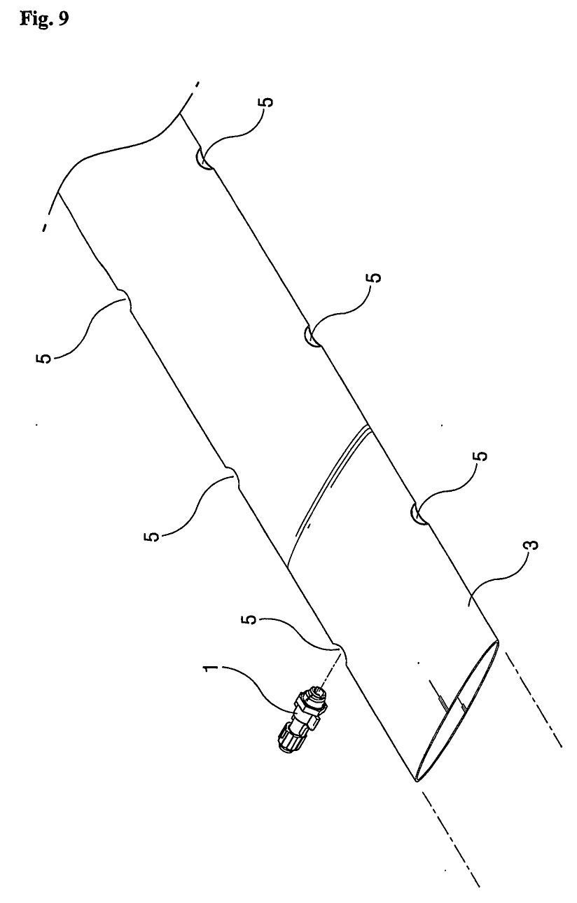

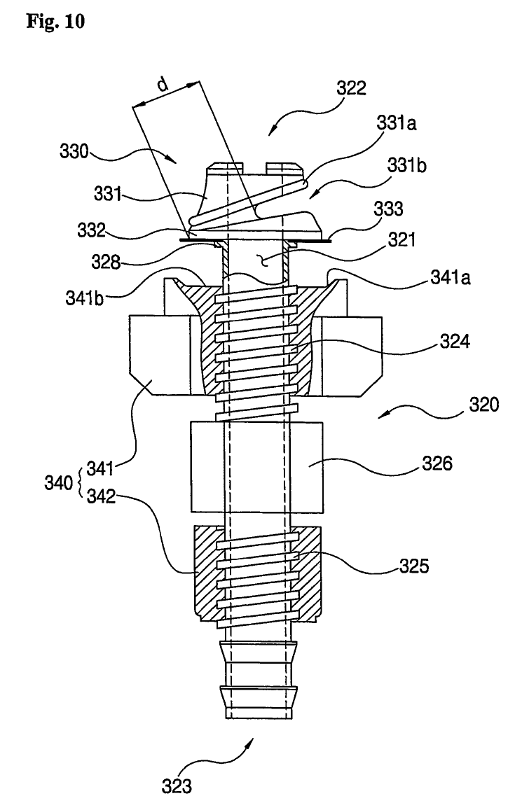

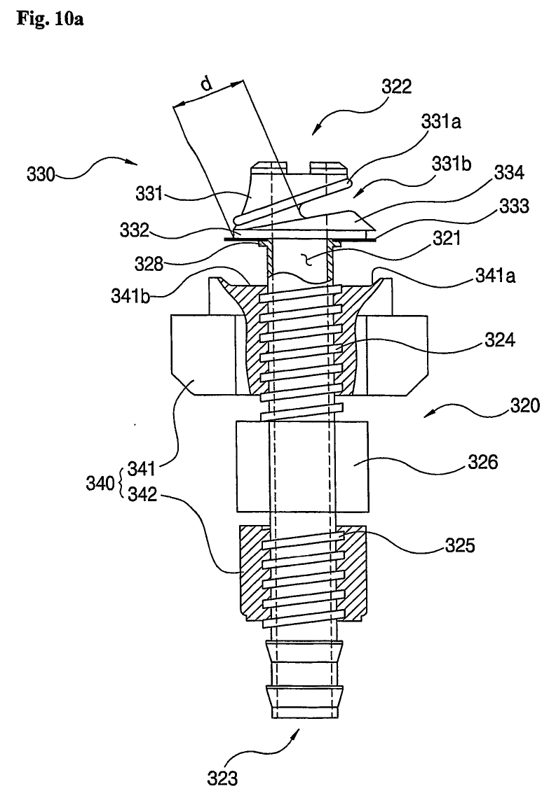

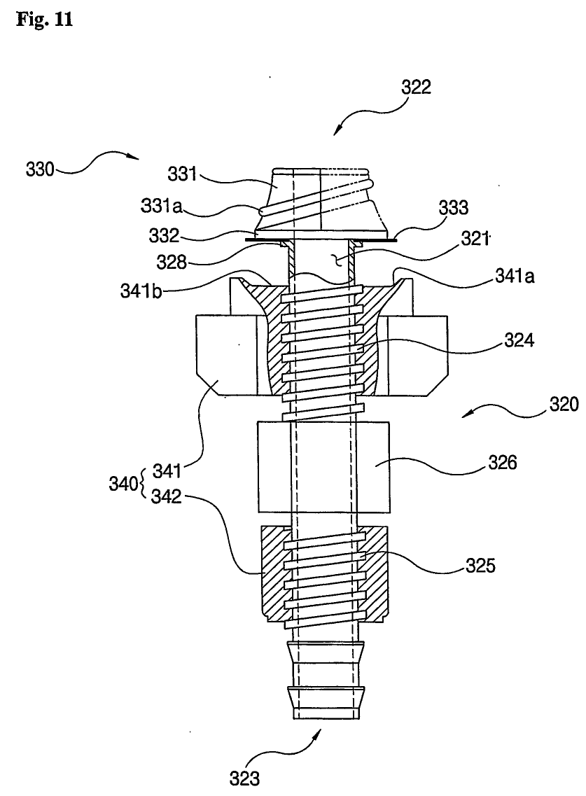

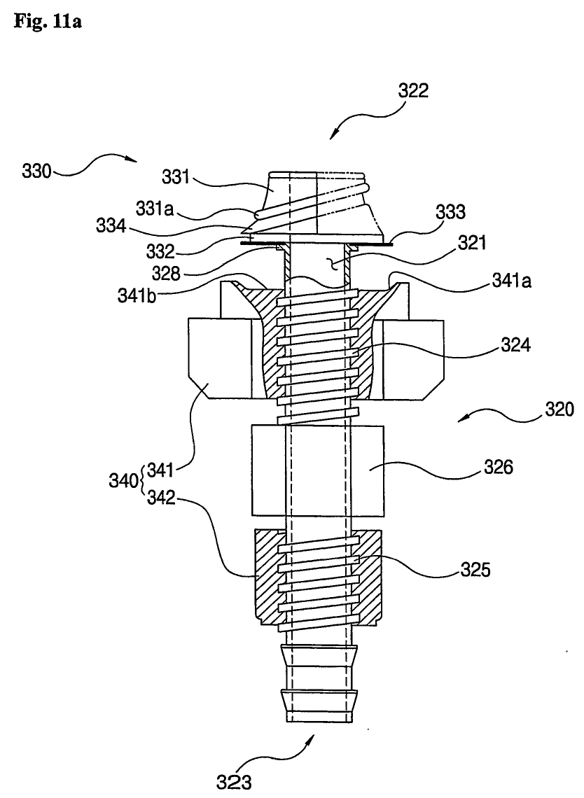

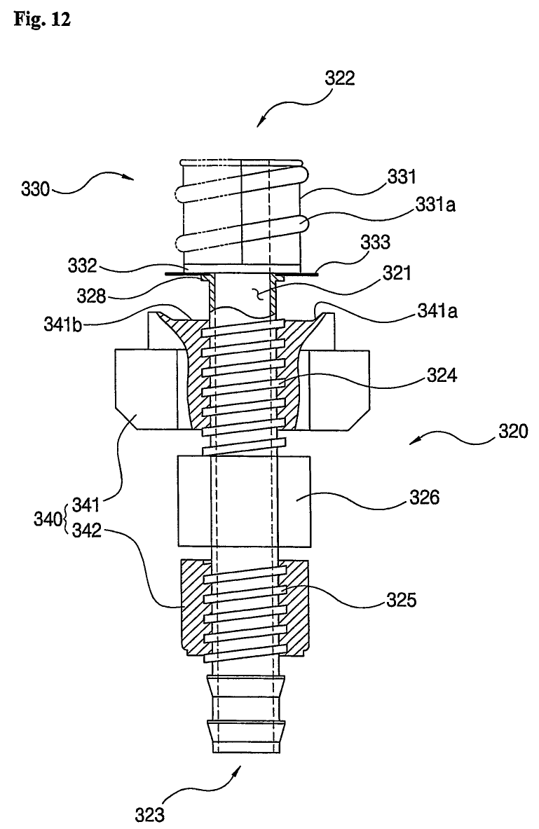

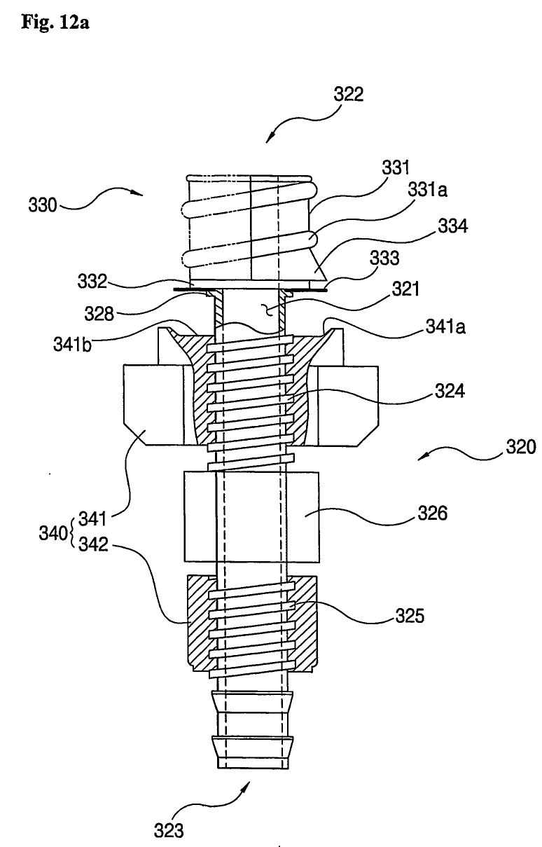

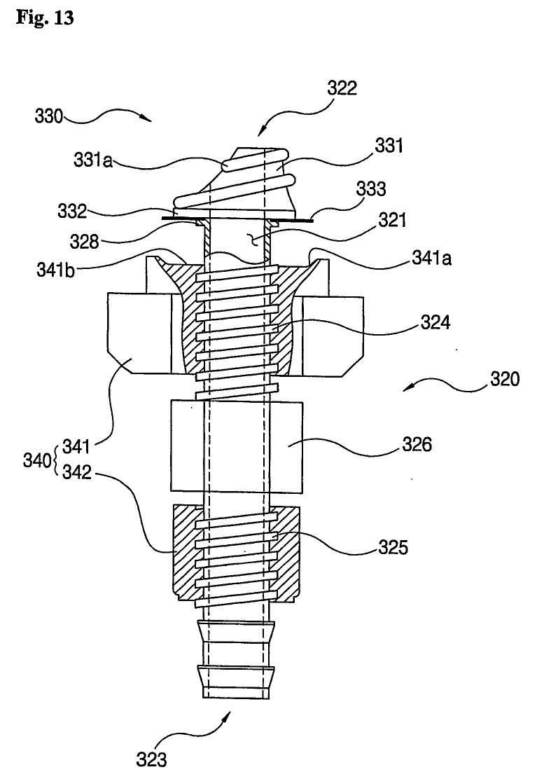

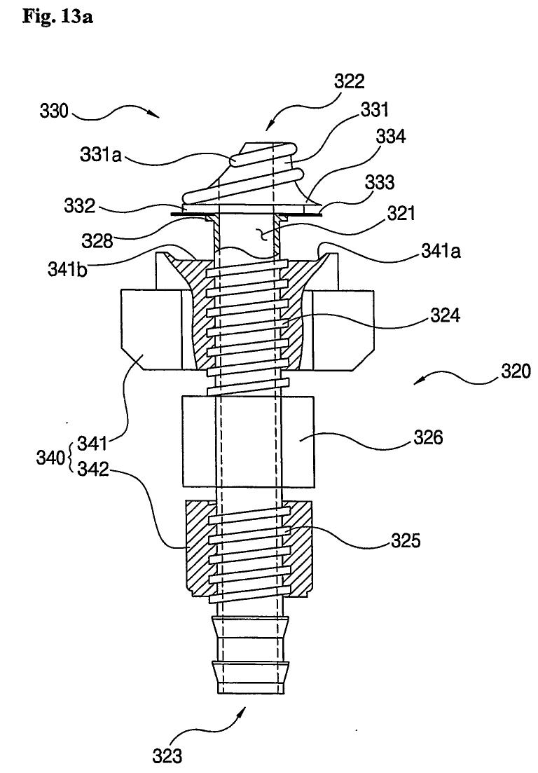

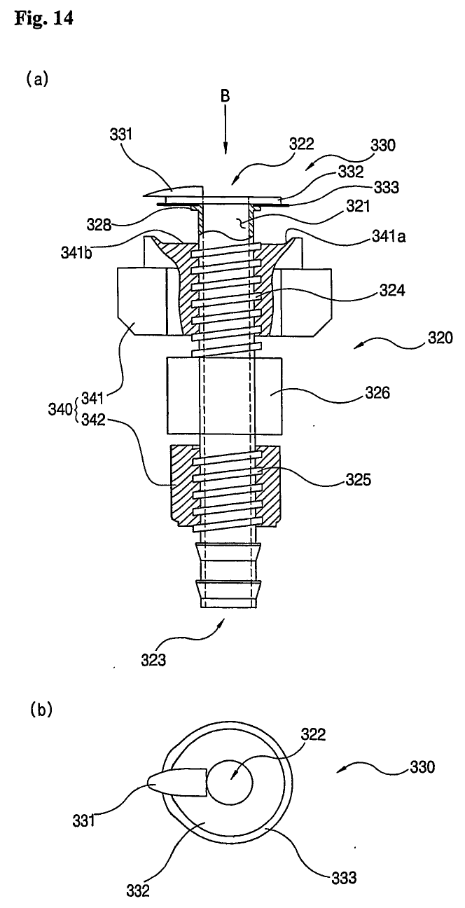

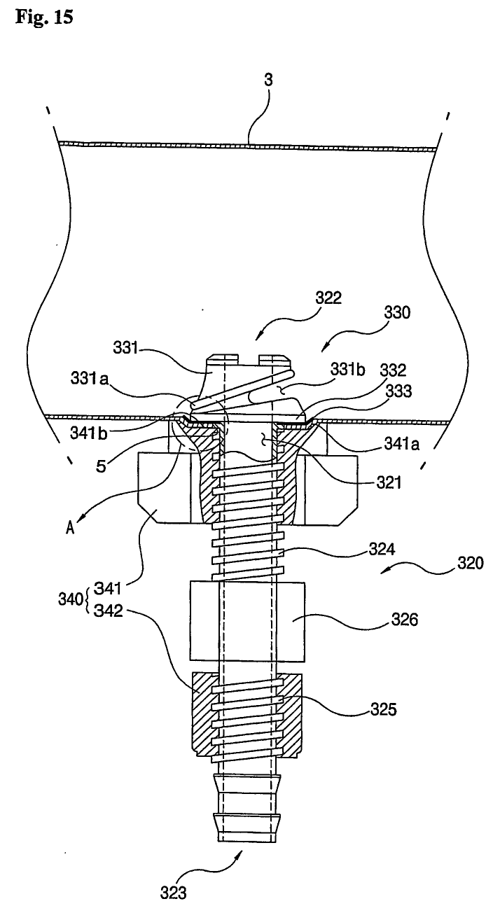

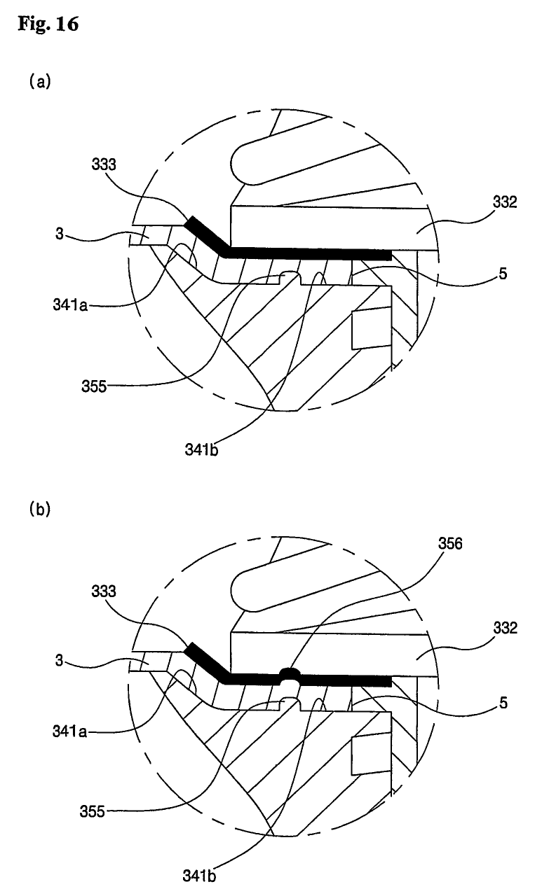

FIG. 9 is a view illustrating a general flexible hose and holes formed on the flexible hose. FIG. 10 is a partial cross-sectional view illustrating an adapter for branching a hose according to a fourth embodiment of the present invention. FIG. 10a is a partial cross-sectional view illustrating an alternative example of an adapter for branching a hose according to a fourth embodiment of the present invention. FIG. 11 is a partially cross-sectional view illustrating an adapter for branching a hose according to a fifth embodiment of the present invention. FIG. 11a is a partial cross-sectional view illustrating an alternative example of an adapter for branching a hose according to a fifth embodiment of the present invention. FIG. 12 is a partial cross-sectional view illustrating an adapter for branching a hose according to a sixth embodiment of the present invention. FIG. 12a is a partial cross-sectional view illustrating an alternative example of an adapter for branching a hose according to a sixth embodiment of the present invention. FIG. 13 is a partial cross-sectional view illustrating an adapter for branching a hose according to a seventh embodiment of the present invention. FIG. 13a is a partial cross-sectional view illustrating an alternative example of an adapter for branching a hose according to a seventh embodiment of the present invention. FIG. 14a is a partial cross-sectional view illustrating an adapter for branching a hose according to an eighth embodiment of the present invention. FIG. 14b is a top view of FIG. 14a taken along the direction of arrow B. FIG. 15 is a view illustrating a state wherein an adapter for branching a hose according to the present invention is installed on a hole of a hose. FIGS. 16a and 16b are enlarged views of portion A of FIG. 15.

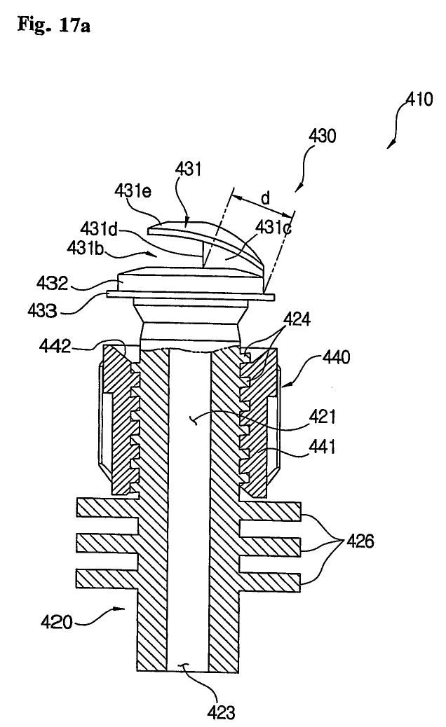

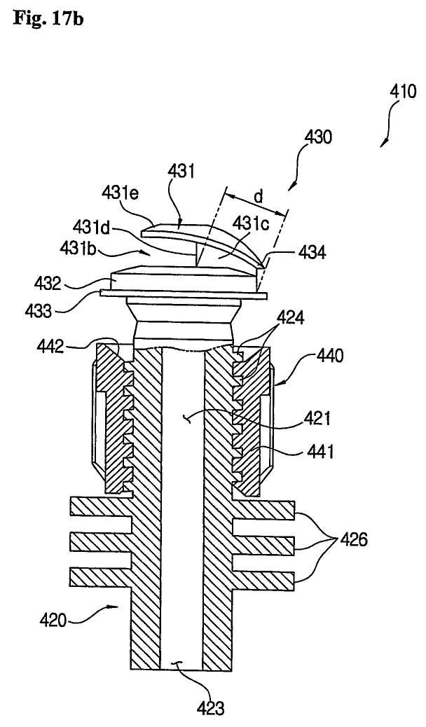

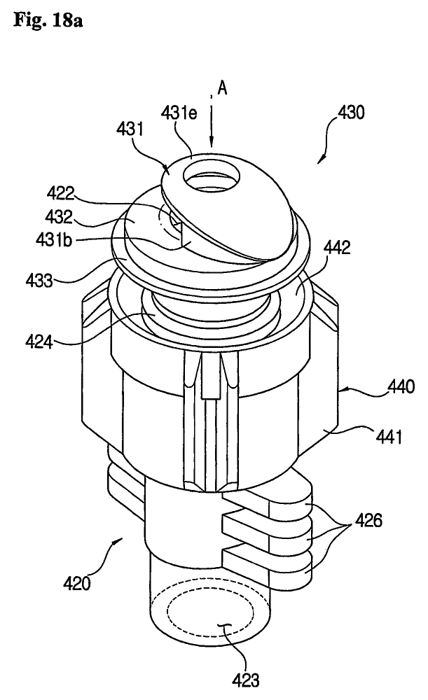

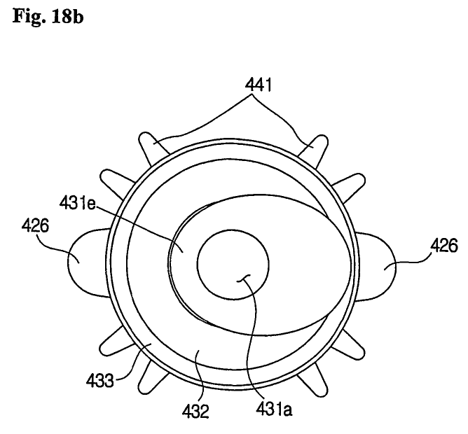

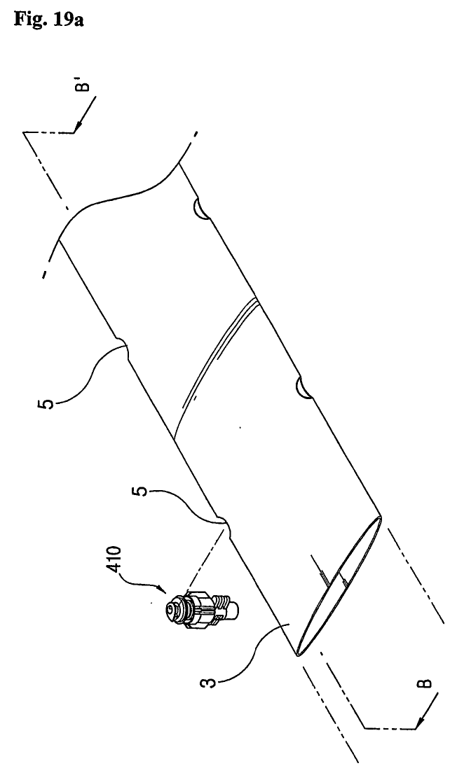

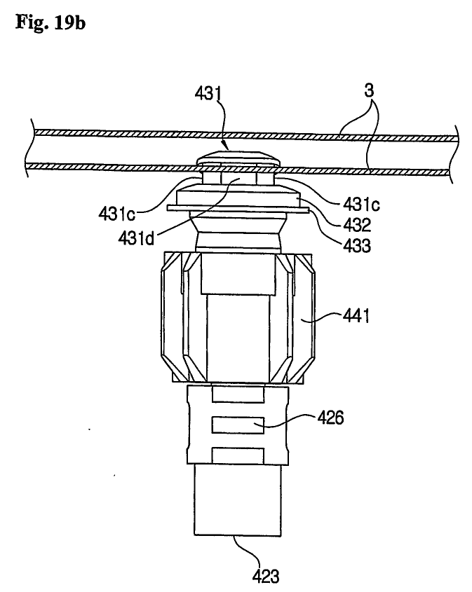

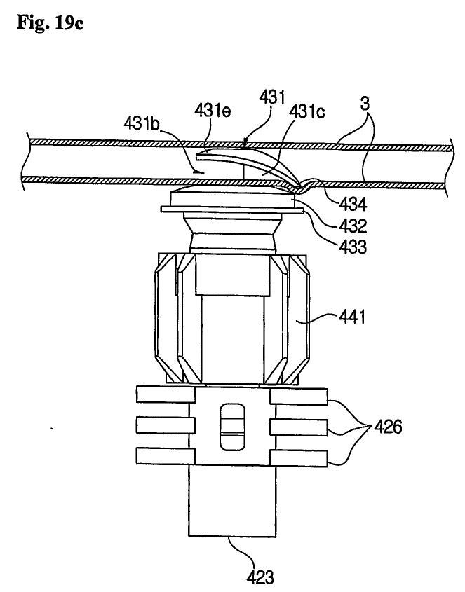

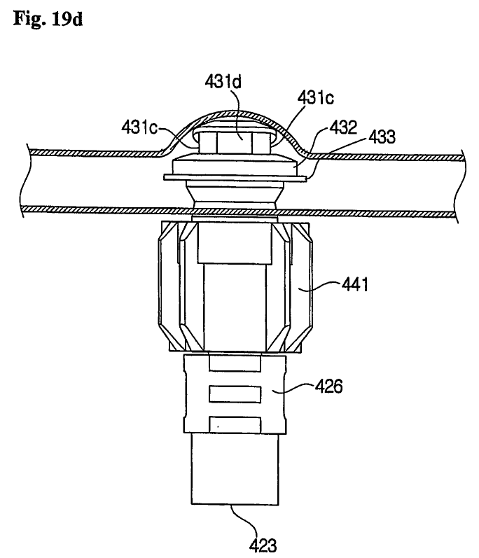

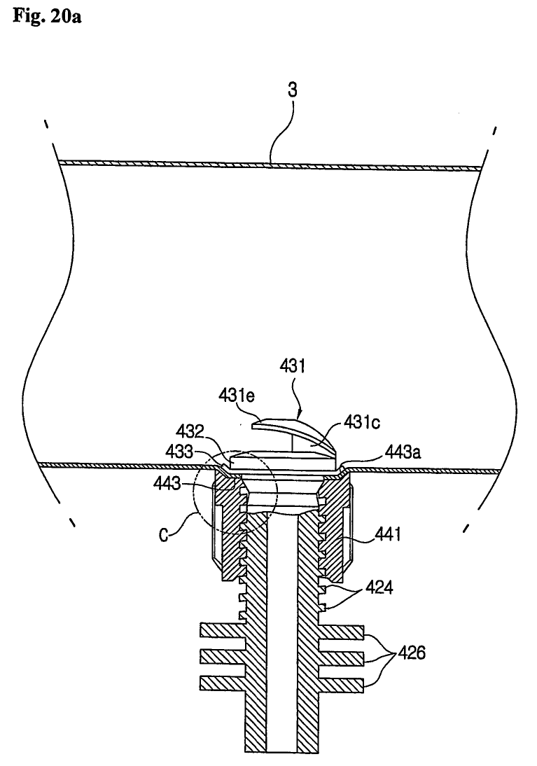

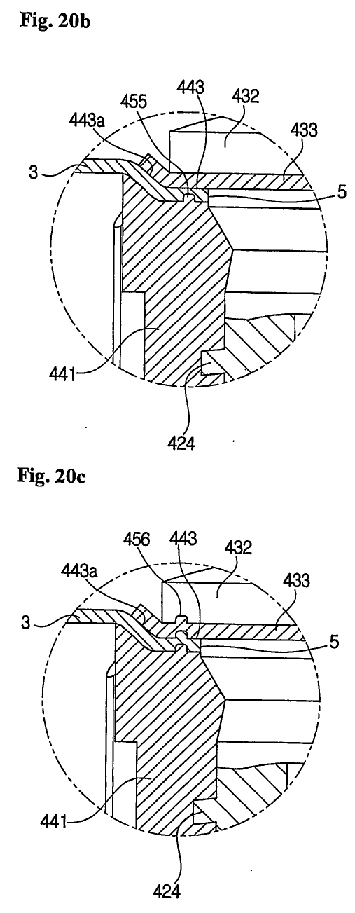

Also, FIG. 17a is a partially cross-sectional view illustrating an adapter for branching a hose according to a ninth embodiment of the present invention. FIG. 17b is a partial cross-sectional view illustrating an adapter for branching a hose, in which an inserting unit is modified from the ninth embodiment of the present invention. FIG. 18a is a perspective view illustrating an adapter for branching a hose according to a ninth embodiment of the present invention. FIG. 18b is a top view of FIG. 18a taken along the direction of arrow B. FIG. 19a is a perspective view illustrating a state before a adapter for branching a hose according to a ninth embodiment of the present invention is inserted into a hole of a flexible hose. FIG. 19b is a cross-sectional view of FIG. 19a taken along line B-B′. FIG. 19c is a cross-sectional view of FIG. 19b, clockwise rotated by 90°. FIG. 19d is a cross-sectional view of FIG. 19c illustrating a state after the manifold member for a hose is fitted in the hole of the flexible hose as it is rotated and pressed. FIG. 20a is a cross-sectional view illustrating a state wherein the manifold member for a hose according to the ninth embodiment of the present invention is completely coupled to the hole. FIG. 20b is a partially enlarged view of portion C of FIG. 20a, illustrating a state wherein a sealing protrusion unit is added to the manifold member for a hose. FIG. 20c is a partially enlarged view of portion C of FIG. 20a, illustrating a state wherein sealing grooves are added to the manifold member for a hose.

FIGS. 9 to 16 are described in detail below.

The adapter for branching a hose according to the present invention includes a body 320, a head 330 and a coupling unit 340.

The body 320 includes a passage 321 through which fluid passes in the inside thereof, an inlet 322 formed at one end thereof to be inserted into a hose 3, and an outlet 323 formed at the other end thereof, in which the outlet is protrudently installed to the hose 3. The body 320 includes first and second male screws 324 and 325 formed on the outer surface thereof at predetermined positions adjacent to the inlet and the outlet sides, respectively. The body 320 includes more than at least one stopper 326 outwardly protrudently formed between the first and second male screws 324 and 325 to prevent first and second coupling members 341 and 342, which will be described later, from interfering with one another when the first and second coupling members 341 and 342 are coupled to the first and second male screws 324 and 325, respectively.

The head 330 is assembled to the inlet side of the body 320 in a screw connection manner or insertion connection manner or is formed to be integratedly configured with the inlet 322.

The head 330 includes an inserting unit 331 guiding the head 330 to a hole 5 of the hose 3, in which the inserting unit 331 is installed at the upper side of the head, and a pressing unit 332 applying a pressure to the edge of inner wall surface of the hole 5, in which the pressing unit 332 is installed at the lower side of the inserting unit 331. Preferably, the diameter of the pressing unit 332 is formed to be greater than that of the hole 5 of the hose 3.

Also, the adapter further includes a packing member 333 made of rubber, etc. at the lower side of the pressing unit 332.

On the other hand, the adapter includes a locking step 328 protruded from the body at the lower side of the head 330 of the body 320 in the radial direction, in which the locking step 328 prevents the packing from escaping from the lower side of the head 330.

The coupling unit 340 includes first and second coupling members 341 and 342 which are coupled to the first and second male screws 324 and 325, respectively.

The first coupling member 341 is coupled to the first male screw 324 towards the pressing unit 332 and the packing member 333 of the head 330, in a state wherein the head 330 is inserted into the hole 5 of the hose 3, such that the pressing unit 3 32 and the packing member 333 press the edge of the inner wall surface of the hole 5 and the first coupling member 341 presses the edge of the outer wall surface of the hole 5, thereby enhancing the seal between the adapter and the hole 5.

Also, the second coupling member 342 is coupled to the second male screw 325 toward an additional manifold (not shown), in a state wherein the additional manifold is insertedly connected to the outlet side of the body 320, such that the additional manifold can be connected to the outlet side.

On the other hand, for similar or corresponding parts between the present invention and Korean Patent Application No. 10-2003-0089451, filed by the present applicant, the present invention refers to the contents disclosed therein.

One of the features of the present invention is structure of the inserting unit 331 of the head 330 such that the inserting unit 331 can easily guide insertion of the head to a hole in a hose 3 flat folded in the diameter direction. The structure of the inserting unit 331 of the head 330 will now be described in detail according to each of the embodiments of the present invention.

FIG. 10 is a partial cross-sectional view illustrating an adapter for branching a hose according to a fourth embodiment of the present invention.

As shown in the drawing, the adapter for branching a hose of the fourth embodiment of the present invention is formed such that an inserting unit 331 of a head 330 has a screw 331a (a male screw or female screw) and is shaped as a cone. Here, a part (a screw thread or screw groove) of the screw 331a is formed to be inwardly cut by a cut part 331b.

On the other hand, the shortest distance d between the cutting part 331b and an edge of a pressing unit 332 of the head 330 is preferably formed to be smaller than the diameter of a hole 5 of a hose 3.

When an upper portion of the inserting unit 331 is inserted into the hole 5 and the inserting unit 331 is rotated along the angle of the screw 331a, the cut part 331b is hooked at the edge of the hole 5 of a flat folded hose 3.

When the opposite side of the cut part 331b of the inserting unit 331 is pressed toward the hole 5 in such a state wherein the cut part 331b is hooked at the edge of the hole 5 of a flat folded hose 3, even if the hose 3 is flat folded, the inserting unit 331 of the head 330 can be easily inserted into the hole 5. Therefore, the pressing unit 332 and a packing member 333 are also easily inserted into the hole 5.

Namely, the feature of the fourth embodiment of the present invention is to easily guide the head insertion into the hole 5 as the cut part 331b enables the inserting unit 331 of the head 330 to be easily hooked to the edge of the hole 5.

FIG. 10a is a partial cross-sectional view illustrating an alternative example of a adapter for branching a hose according to a fourth embodiment of the present invention, in which it further includes a protrusion unit 334 a boundary surface between the inserting unit 331 and the pressing unit 332, which is partially protruded from one side of the lower portion of the inserting unit 331 to the outside. Also, by formation of the protrusion unit 334 a step is formed between the pressing unit 332 and the protrusion unit 334. As the step is simply hooked at the edge of the hole 5, an insertion guide operation of the head 330 can be effectively performed.

FIG. 11 is a partial cross-sectional view illustrating an adapter for branching a hose according to a fifth embodiment of the present invention.

As shown in the drawing, the adapter for branching a hose of the fifth embodiment of the present invention is formed such that an inserting unit 331 of a head 330 has a screw 331a (a male screw or female screw) and is shaped as a cone. Here, a part (approximately a half or ⅓) of the screw 331a is formed to be vertically cut off.

Since the inserting unit 331 partially cut and cone-shaped has a structure wherein its volume is reduced, it can be easily inserted into the hole 5 of the hose 3. Therefore, the pressing unit 332 and a packing member 333 are also easily inserted into the hole 5.

FIG. 11a is a partial cross-sectional view illustrating an alternative example of a adapter for branching a hose according to a fifth embodiment of the present invention, in which it further includes a protrusion unit 334 a boundary surface between the partially cut and cone-shaped inserting unit 331 and the pressing unit 332, which is partially protruded from one side of the lower portion of the inserting unit 331 to the outside. Also, from formation of the protrusion unit 334, a step is formed between the pressing unit 332 and the protrusion unit 334. As the step is simply hooked at the edge of the hole 5, an insertion guide operation of the head 330 can be effectively performed.

FIG. 12 is a partial cross-sectional view illustrating an adapter for branching a hose according to a sixth embodiment of the present invention,

As shown in the drawing, the adapter for branching a hose of the sixth embodiment of the present invention is formed such that an inserting unit 331 of a head 330 has a screw 331a (a male screw or female screw) and is shaped as a cylinder. Here, a part (approximately a half or third) of the screw 331a is formed to be vertically cut off.

Since the inserting unit 331 partially cut and cylinder-shaped has a structure wherein its volume is reduced, it can be easily inserted into the hole 5 of the hose 3. Therefore, the pressing unit 332 and a packing member 333 are also easily inserted into the hole 5.

FIG. 12a is a partial cross-sectional view illustrating an alternative example of a adapter for branching a hose according to a sixth embodiment of the present invention, in which it further includes a protrusion unit 334 a boundary surface between the partially cut and cylinder-shaped inserting unit 331 and the pressing unit 332, which is partially protruded from one side of the lower portion of the inserting unit 331 to the outside. Also, from formation of the protrusion unit 334, a step is formed between the pressing unit 332 and the protrusion unit 334. As the step is simply hooked at the edge of the hole 5, an insertion guide operation of the head 330 can be effectively performed.

FIG. 13 is a partial cross-sectional view illustrating an adapter for branching a hose according to a seventh embodiment of the present invention.

As shown in the drawing, the adapter for branching a hose of the seventh embodiment of the present invention is formed such that an inserting unit 331 of a head 330 is shaped as a cone whose vertex is eccentric from the axis of the adapter, in which the outer surface of the eccentric cone-shaped inserting unit 331 has a screw 331a (a male screw or female screw).

When the eccentric cone-shaped inserting unit 331 is inserted into the hole 5 of a flat folded hose 3, it can be easily rotated and inserted into the hole 5 of the hose 3. Therefore, the pressing unit 332 and a packing member 333 are also easily inserted into the hole 5.

FIG. 13a is a partial cross-sectional view illustrating an alternative example of a adapter for branching a hose according to a seventh embodiment of the present invention, in which it further includes a protrusion unit 334 a boundary surface between the eccentric cone-shaped inserting unit 331 and the pressing unit 332, which is partially protruded from one side of the lower portion of the eccentric cone-shaped inserting unit 331 to the outside. Also, from formation of the protrusion unit 334, a step is formed between the pressing unit 332 and the protrusion unit 334. As the step is simply hooked at the edge of the hole 5, an insertion guide operation of the head 330 can be effectively performed.

FIG. 14a is a partial cross-sectional view illustrating a adapter for branching a hose according to an eighth embodiment of the present invention and FIG. 14b is a top view of FIG. 14a taken along the direction of arrow B.

As shown in the drawings, the adapter for branching a hose of the eighth embodiment of the present invention is formed such that an inserting unit 331 of a head 330 is shaped as a protruding tip protruded at one side in the radial direction on the upper surface of the pressing unit 332.

Since the inserting unit 331 shaped as a protruding tip is simply hooked at the edge of the hole 5 of a flat folded hose 3, the inserting unit 331 of the head 330 can be easily inserted into the hole 5. Therefore, the pressing unit 332 and a packing member 333 are also easily inserted into the hole 5.

FIG. 15 is a view illustrating a state wherein the adapter for branching a hose according to the fourth embodiment of the present invention is installed on a hole of a hose. The adapter includes a locking step 328 protruded in the radial direction at the lower side of the head 330 of the body 320, in which the locking step 328 prevents a packing member 333 coupled to the lower side of the head 330 from escaping, a taper unit 341a at the inner circular surface of the upper portion of the first coupling member 341 of the coupling unit 340, and a flat surface 341b inside of the taper unit 341a, in which the flat surface 341b presses the external surface of the edge of the hole 5 toward the packing member 333 and the pressing unit 332 of the head 330. Here, the diameter of the upper portion of the taper unit 341a is preferably formed to be greater than that of the pressing unit 332 of the head 330.

As shown in FIG. 15, as the first coupling member 341 is pressed and coupled toward the pressing unit 332 of the head 330, the taper unit 341a tightly seals the packing member 333 and the edge of the hole 5. Therefore, the connection portion between the adapter and the hole 5 can be more tightly sealed.

Although the configuration of the locking step 328 of the body 320, the taper surface 341a of the first coupling member 341, and the flat surface 341b is implemented in the fourth embodiment of the present invention, the configuration may be applied to the other embodiments of the present invention.

As shown in FIG. 16a, the flat surface 341b of the first coupling member 341 may further include a circular sealing protrusion unit 355 protrudently formed thereon.

Therefore, the circular sealing protrusion unit 355 can enhance the seal between the edge of the hole 5 and the packing member 333 as it tightly seals therebetween.

Even though the circular sealing protrusion unit 355 according to the embodiment of the present invention is implemented to be formed on the flat surface 341b, it may be formed on the lower surface of the pressing unit 332 of the head 330.

Also, as shown in FIG. 16b, a circular sealing groove 356 is correspondingly formed opposite the circular sealing protrusion unit 355, thereby enhancing sealing therebetween.

FIGS. 17 to 20 are described in detail below.

The adapter 410 for a hose according to the present invention includes a body 420, a head 430 and a coupling unit 440.

The body 420 includes a passage 421 through which fluid passes in the inside thereof, an inlet 422 formed at one end thereof to be inserted into a hose 3, and an outlet 423 formed at the other end thereof, in which the outlet is protrudently installed to the hose 3. The body 420 includes a male screw 424 formed on the outer surface thereof at predetermined positions adjacent to the inlet side. The body 320 includes more than at least one stopper 426 outwardly protrudently formed at the end of the male screw 424, in which the stopper 426 prevents a coupling member 441, a manifold (not shown) coupled to the outlet 423, or another coupling member (not shown) of the manifold, which will be described later, from interfering with one another when they are coupled to one another.

The head 430 is assembled to the inlet side of the body 420 in a screw connection manner, etc., or is formed to be integratedly configured with the inlet 422.

The head 430 includes an inserting unit 431 guiding the head 430 to a hole 5 of the hose 3, in which the inserting unit 431 is installed at the upper side of the head, and a circular pressing unit 432 applying a pressure to the edge of the inner wall surface of the hole 5, in which the circular pressing unit 432 is installed at the lower side of the inserting unit 431. Preferably, the diameter of the circular pressing unit 432 is formed to be greater than that of the hole 5 of the hose 3.

Also, the adapter further includes a circular packing member 433 made of rubber, etc. at the lower side of the circular pressing unit 432, thereby enhancing sealing therebetween.

The coupling unit 440 includes a coupling member 441 forming a female screw in the inner circular side thereof and individually coupling to the male screw 424 of the body 420.

The coupling member 441 is coupled to the male screw 424 towards the pressing unit 432 and the packing member 433 of the head 430, in a state wherein the head 430 is inserted into the hole 5 of the hose 3, such that the pressing unit 432 and the packing member 433 press the edge of the inner wall surface of the hole 5 and the coupling member 441 presses the edge of the outer wall surface of the hole 5, thereby enhancing the seal between the adapter and the hole 5.

Also, the outlet 423 of the body 420 is coupled to a manifold (not shown) in general coupling manners such as an insertion connection manner or a screw connection manner, etc., or integratedly formed with the manifold, such that fluid passing though the hose 3 can be separated to various directions by the manifold.

One of the features of the present invention is structure of the inserting unit 431 of the head 430 such that the inserting unit 431 can easily guide insertion of the head to a hole in a hose 3 flat folded in the diameter direction. Now, the structure of the inserting unit 431 of the head 430 is described in detail according to the preferred embodiment of the present invention.

As shown in FIGS. 17a, 17b, 18a and 18b, the adapter for branching a hose according to the ninth embodiment of the present invention is formed such that an inserting unit 431 of a head 430 is formed irregularly, or is formed as a part of a hemisphere. Namely, the inserting unit 431 is formed such that three quarters 431b with respect to the vertex of the hemisphere are cut off leaving a quarter of the hemisphere and the inlet hole 431 a close to the vertex, with respect to a top view, and cut off at a part of the inlet 422, with respect to a cross-sectional view of the inserting unit 431. A guide groove 431c is formed one side of both sides of the connection portion between the inserting unit 431 and the pressing unit 433 such that the inserting unit can be guided to be smoothly inserted thereinto.

Since the inserting unit 431 of the head 430 is cut off by three quarters, the inserting unit 431 is reduced in volume, thereby being easily hooked into the hose 3 though the hole 5. Therefore, when the inserting unit 431 is inserted into the hose 3, the insertion operation can be easily performed. Also, since the guiding groove 431c is guided for insertion along the periphery of the hole 5, the inserting unit can be more easily inserted into the hole 5. According to the relatively easy insertion operation for the inserting unit 431 of the head 430, the pressing unit 432 and the packing member 433 are also easily inserted thereto.

On the other hand, the shortest distance d between the cut part 431b and an edge part of the pressing unit 432 of the head 430 is preferably smaller than a diameter of the hole 5 of the hose 3.

FIGS. 19a to 19d are views describing a method for coupling the adapter to a hose. After the adapter 410 is positioned nearby a hole 5 of the hose 3, when an end 431e of the inserting unit 431 of the adapter 410 is hooked and inserted into the hole 5, an end portion 431d of the cut part 431b reaches the outer surface of the hole 5 (See FIG. 19b). At this time, if the adapter 410 is rotated 90° clockwise, with respect to the top view, and then inserted at a predetermined pressure, the inserting unit 431 is inserted into the hose 3 along the guide groove 431c (See FIG. 19c). In this state, if the adapter 410 is further rotated and inserted applying a pressure thereto, the upper portion of the body 420 is also inserted into the hose 3 such that even the pressing unit 432 and the packing member 433 can be inserted into the hose 3 (See FIG. 19d). After that, the adapter 410 is pulled against the hose 3 such that the lower surface of the packing member 433 can be closely connected to the inner wall surface at the edge of the hole 5 of the hose 3. Here, in general, the guide groove 431c is formed right with respect to the front view of the end 431e of the inserting unit 431, but may be formed left considering left-handed people who rotates the adapter counter clockwise. Also, the guide groove 431c may be formed both sides at the adapter regardless of right-handed and left-handed people.

Also, as shown in FIG. 18b, a protrusion unit formed at the end of the inserting unit 431 can be simply hooked at the edge of the hole 5 such that the adapter can be easily inserted into the hole 5 of the hose 3.

As such, after the packing member 433 of the head 3 of the adapter 410 is closely stuck to the inner wall surface at the edge of the hole 5 of the hose 3, when the coupling member 441 is rotated, the coupling member 441 is moved upward by the male screw 424. At the same time, the slope surface 442 is closely stuck to the outer wall surface at the edge of the hole 5 of the hose 3 and the packing member 433 is closely stuck to the inner wall surface at the edge of the hole 5 of the hose 3 and the lower surface of the pressing unit 432. Therefore, the adapter secures sealing such that fluid passing though the hose 3 cannot leak from the hole 5.

As shown in FIGS. 19a to 19d and 20a to 20c, the adapter 410 is tightly connected to a hose by the coupling member 441 in a screw connection manner. The coupling member 441 is formed by modifying the slope surface 442 in the inside thereof. Namely, a flat surface 443 and a taper unit 443a are formed to enhance sealing of the adapter (See FIG. 20a).

On the other hand, the flat surface 443 may form a circular sealing protrusion unit 445 (See FIG. 20b) thereon such that the outer wall surface at the edge of the hole 5 of the hose 3 and the packing member 433 can be more closely stuck to one another. Also, the pressing unit 432 may form a circular sealing groove 456 corresponding to the circular sealing protrusion unit 455 on the lower surface thereof such that the seal between the outer wall surface at the edge of the hole 5 of the hose 3 and the packing member 433 can be maximumly increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A adapter for branching a hose, insertedly connected to an edge of the hose, to distribute fluid flowing through the hose, comprising:
a body for conveying the fluid, the body including an inlet and outlet at its one end and other, respectively;
a head formed at a predetermined position of the inlet side of the body, the head being formed as a cone being tapered one end to the other; and
a coupling unit including a first coupling unit at the inlet side of the body and a second coupling unit at the outlet side of the body.

2. The adapter according to claim 1, wherein the head includes a screw groove formed at a predetermined size on its outer surface sloping at a predetermined angle.

3. The adapter according to claim 1, wherein the head includes a screw thread outwardly protrudently formed on its outer surface sloping at a predetermined angle.

4. The adapter according to one of claims 1 to 3, wherein the head and the body are coupled to each other such that forms female screws formed on inner surface of the head are coupled to male screws formed at the inlet side of the body or female screws formed on one side of the outer surface of the head are coupled to male screws formed on the inner surface of the inlet side of the body.

5. The adapter according to one of claims 1 to 3, further comprising a locking step unit outwardly protrudently formed such that the head coupled to the outer edge at the end of the inlet side of the body cannot be separated therefrom.

6. The adapter according to claim 5, wherein the outer edge at the end of the inlet side of the body includes an extension groove which is formed by cutting lengthwise, and extensible, in which more than one extension grooves are formed by cutting along its periphery direction.

7. The adapter according to claim 6, wherein the head includes an extension plate at a predetermined position in the inner surface thereof, the number of the extension plate being formed to be equal to that of the extension groove, in which the extension plate is insertedly coupled to the extension groove.

8. The adapter according to claim 7, wherein the extension plate is gradually decreased in size from one end to the other.

9. The adapter according to claim 6, further comprising a cylinder shaped head cap whose diameter is gradually decreased from one end to the other, in which the head cap includes a fixing step outwardly protrudently formed at one end of the outer surface thereof and is insertedly connected to the end of the inlet of the body, in which the extension groove is formed.

10. The adapter according to one of claims 1 to 3, wherein the head includes a plate shaped packing at one side of the head.

11. The adapter according to one of claims 1 to 3, wherein one end of the head is formed to be wedged at a predetermined angle.

12. The adapter according to claim 11, wherein the head and the body are coupled to each other such that forms female screws formed on inner surface of the head are coupled to male screws formed at the inlet side of the body or female screws formed on one side of the outer surface of the head are coupled to male screws formed on the inner surface of the inlet side of the body.

13. The adapter according to claim 11, wherein the head includes a screw groove formed at a predetermined size on its outer surface, sloping at a predetermined angle.

14. The adapter according to claim 11, wherein the head includes a screw thread outwardly protrudently formed on its outer surface, sloping at a predetermined angle.

15. The adapter according to claim 11, further comprising a locking step unit outwardly protrudently formed such that the head coupled to the outer edge at the end of the inlet side of the body cannot be separated therefrom.

16. The adapter according to claim 11, wherein the outer edge at the end of the inlet side of the body includes an extension groove which is formed by cutting lengthwise, and extensible, in which plural extension grooves are formed by cutting along its periphery direction.

17. The adapter according to claim 16, wherein the head includes an extension plate at a predetermined position in the inner surface thereof, the number of the extension plate being formed to be equal to that of the extension groove, in which the extension plate is insertedly coupled to the extension groove.

18. The adapter according to claim 17, wherein the extension plate is gradually decreased in size from one end to the other.

19. The adapter according to claim 11, wherein the head includes a packing shaped as a plate at one side of the head.

20. A adapter for branching a hose, comprising:
a body including a passage through which fluid passes, an inlet formed at one end thereof to be inserted into a hose, and an outlet formed at the other end thereof to be connected to the adapter, the outlet being protrudently installed to the hose;
a head formed at the inlet side of the body, the head being insertedly connected to a hole of the hose; and
a coupling unit including a coupling member, in which the coupling member is arranged adjacent to the inlet and coupled to a coupled member such as an inserting groove or screwing unit formed at an outer surface of the body;
wherein the head includes an inserting unit formed irregularly on an upper surface thereof and a pressing unit formed on a lower surface thereof, in which the inserting unit has a width smaller than that of the pressing unit and the pressing unit has a diameter greater than that of the hole of the hose.

21. The adapter according to claim 20, wherein the inserting unit includes a screw unit shaped as a cone, in which one part of the screw unit is inwardly cut, the shortest distance between the cut part and the lower surface of the head is smaller than the diameter of the hole of the hose.

22. The adapter according to claim 21, wherein the head includes a protrusion unit at a boundary surface between the inserting unit and the pressing unit, in which the protrusion unit is partially protruded from the inserting unit to the outside thereof, and a step formed between the pressing unit and the protrusion unit.

23. The adapter according to claim 20, wherein the inserting unit includes a cone shaped screw unit, in which one part of the screw unit is cut.

24. The adapter according to claim 23, wherein the head includes a protrusion unit at a boundary surface between the inserting unit and the pressing unit, in which the protrusion unit is partially protruded from the inserting unit to the outside thereof, and a step is formed between the pressing unit and the protrusion unit.

25. The adapter according to claim 20, wherein the inserting unit includes a screw unit shaped as a cylinder, in which one part of the screw unit is cut.

26. The adapter according to claim 25, wherein the head includes a protrusion unit at a boundary surface between the inserting unit and the pressing unit, in which the protrusion unit is partially protruded from the inserting unit to the outside thereof, and a step is formed between the pressing unit and the protrusion unit.

27. The adapter according to claim 20, wherein the head is shaped as a cone whose vertex is eccentric.

28. The adapter according to claim 27, wherein the head includes a protrusion unit at a boundary surface between the inserting unit and the pressing unit, in which the protrusion unit is partially protruded from the inserting unit to the outside thereof, and a step formed between the pressing unit and the protrusion unit.

29. The adapter according to claim 20, wherein the inserting unit is shaped as a protrusion tip partially protruded to outer radius of the pressing unit.

30. The adapter according to one of claims 20 to 29, wherein the coupling member includes a taper unit on the upper side thereof, in which the taper unit includes a flat surface in the inside thereof and forms a diameter on the upper side thereof, which is larger than that of the pressing of the head.

31. The adapter according to claim 30, further comprising a sealing protrusion unit circularly extended and protruded at one surface of the flat surface of the coupling member and the pressing unit of the head.

32. The adapter according to claim 31, further comprising a sealing groove opposite to a part to which the sealing protrusion unit is installed.

33. A adapter for branching a hose, comprising:
a body including a passage through which fluid passes in the inside thereof, an inlet formed at one end thereof to be inserted into a hose, and an outlet formed at the other end thereof to be connected to the adapter, the outlet being protrudently installed to the hose;
a head formed at the inlet side of the body, the head being insertedly connected to a hole of the hose and including a packing member installed to the lower surface thereof;
a locking step unit for fixing the packing member, the locking step unit being protruded to the outer radius at the lower position of the body; and
a coupling unit including first and second coupling members, in which the first and second coupling members are adjacently arranged to the inlet and the outlet, respectively, and coupled to a screw unit formed at an outer surface of the body;
wherein the head includes an inserting unit irregularly formed on an upper surface thereof and a pressing unit formed on a lower surface thereof, in which the inserting unit has a width smaller than that of the pressing unit and the pressing unit has a diameter greater than that of the hole of the hose.

34. The adapter according to claim 33, wherein the inserting unit includes a screw unit shaped as a cone, in which one part of the screw unit is inwardly cut, the shortest distance between the cut part and the lower surface of the head is smaller than the diameter of the hole of the hose.

35. The adapter according to claim 34, wherein the head includes a protrusion unit at a boundary surface between the inserting unit and the pressing unit, in which the protrusion unit is partially protruded from the inserting unit to the outside thereof, and a step formed between the pressing unit and the protrusion unit.

36. The adapter according to claim 33, wherein the inserting unit includes a screw unit shaped as a cone, in which one part of the screw unit is cut.

37. The adapter according to claim 36, wherein the head includes a protrusion unit at a boundary surface between the inserting unit and the pressing unit, in which the protrusion unit is partially protruded from the inserting unit to the outside thereof, and a step is formed between the pressing unit and the protrusion unit.

38. The adapter according to claim 33, wherein the inserting unit includes a screw unit shaped as a cylinder, in which one part of the screw unit is cut.

39. The adapter according to claim 38, wherein the head includes a protrusion unit at a boundary surface between the inserting unit and the pressing unit, in which the protrusion unit is partially protruded from the inserting unit to the outside thereof, and a step is formed between the pressing unit and the protrusion unit.

40. The adapter according to claim 33, wherein the head is shaped as a cone whose vertex is eccentric.

41. The adapter according to claim 40, wherein the head includes a protrusion unit at a boundary surface between the inserting unit and the pressing unit, in which the protrusion unit is partially protruded from the inserting unit to the outside thereof, and a step is formed between the pressing unit and the protrusion unit.

42. The adapter according to claim 33, wherein the inserting unit is shaped as a protrusion tip partially protruded to outer radius of the pressing unit.

43. The adapter according to one of claims 33 to 42, wherein the coupling member including a taper unit on the upper side thereof, in which the taper unit includes a flat surface in the inside thereof and forms a diameter on the upper side thereof, which is larger than that of the pressing of the head.

44. The adapter according to claim 43, further comprising a sealing protrusion unit circularly extended and protruded at one surface of the flat surface of the coupling member and the pressing unit of the head.

45. The adapter according to claim 44, further comprising a sealing groove opposite to a part to which the sealing protrusion unit is installed.

46. The adapter according to claim 20, further comprising a packing member made of rubber, etc., at the lower side of the pressing unit.

47. The adapter according to claim 20 or 46, wherein the inserting unit of the head is shaped as a part of hemisphere, in which the inserting unit is formed such that three quarters with respect to the vertex of the hemisphere are cut of leaving a quarter of the inserting unit and an inlet hole close to the vertex, with respect to a top view, and cut of at a part of the inlet, with respect to a side view.

48. The adapter according to claim 47, wherein the shortest distance between the cut part and an edge part of the pressing unit of the head is smaller than the diameter of the hole of the hose.

49. The adapter according to claim 48, wherein the coupling unit forms a slope surface at an inner circular surface of the upper side thereof, in which the slope surface increases in diameter from the center to the outer direction, such that the slope surface can apply pressure to an outer surface of the hose in the sloped direction.

50. The adapter according to claim 48, wherein the coupling unit forms a flat surface applying a pressure to the pressing unit, at an inner circular surface of the upper side thereof, and a taper unit from an outer part of the flat surface from the end of the inner circular surface of the upper side thereof.

51. The adapter according to claim 50, wherein the flat surface has an outer diameter greater than the diameter of the pressing unit of the head.

52. The adapter according to claim 47, wherein the pressing unit includes a guide groove at either left or right or both sides thereof such that the pressing unit is smoothly inserted thereinto when the adapter is rotated to be installed to the hose.

53. The adapter according to claim 48, wherein the pressing unit includes a guide groove at either left or right or both sides thereof such that the pressing unit is smoothly inserted thereinto when the adapter is rotated to be installed to the hose.

54. The adapter according to claim 49, wherein the pressing unit includes a guide groove at either left or right or both sides thereof such that the pressing unit is smoothly inserted thereinto when the adapter is rotated to be installed to the hose.

55. The adapter according to claim 50, wherein the pressing unit includes a guide groove at either left or right or both sides thereof such that the pressing unit is smoothly inserted thereinto when the adapter is rotated to be installed to the hose.

56. The adapter according to claim 51, wherein the pressing unit includes a guide groove at either left or right or both sides thereof such that the pressing unit is smoothly inserted thereinto when the adapter is rotated to be installed to the hose.
